(19) United States
(12) Patent Application Publication
(10) Pub. No.: US 2022/0305764 A1
(43) Pub. Date: Sep. 29, 2022

(54) COVER WINDOW, METHOD OF FABRICATING THE COVER WINDOW, AND DISPLAY DEVICE WITH THE COVER WINDOW

(71) Applicant: Samsung Display Co., Ltd., Yongin-si (KR)

(72) Inventors: HYUNSEUNG SEO, Suwon-si (KR); JIHYUN KO, Suwon-si (KR)

(73) Assignee: Samsung Display Co., Ltd., Yongin-si (KR)

(21) Appl. No.: 17/673,336

(22) Filed: Feb. 16, 2022

(30) Foreign Application Priority Data
Mar. 24, 2021 (KR) 10-2021-0037821

(51) Int. Cl. B32B 27/08; B32B 7/022; B32B 7/023; B32B 27/36; B32B 27/30

(52) U.S. Cl. CPC B32B 27/08; B32B 7/022; B32B 7/023; B32B 27/365; B32B 27/308; B32B 2457/20; B32B 2307/536; B32B 2255/10; B32B 2255/28; B32B 2307/4023; B32B 2307/412; B32B 2255/26

(57) ABSTRACT

A cover window may include a polymer film, a printing layer disposed below the polymer film, and a hard coating layer. The hard coating layer may include a first portion disposed on a top surface of the polymer film and overlapping the polymer film, a second portion disposed on a bottom surface of the printing layer and overlapping the printing layer, and a third portion disposed between the first portion and the second portion. An area of the second portion may be smaller than an area of the printing layer in plan view. The cover window including the hard coating layer may have an improved mechanical robustness property and an improved reliability property.

### CROSS-REFERENCE TO RELATED APPLICATION(S)

This U.S. non-provisional patent application claims priority to and benefits of Korean Patent Application No. 10-2021-0037821 under 35 U.S.C. § 119, filed on Mar. 24, 2021 in the Korean Intellectual Property Office, the entire contents of which are hereby incorporated by reference.

### BACKGROUND OF THE INVENTION

### 1. Technical Field

The disclosure relates to a cover window including a hard coating layer, a method of fabricating the cover window, and a display device including the cover window.

### 2. Discussion of the Related Art

A display device includes a display screen, which may be used to display image information to a user. In general, the display device may display information within a given display screen. The display device may further include a cover window that may be provided to protect internal components of the display device.

The cover window may include a polymer film and may be easily broken in case that it is exposed to an external impact. Thus, it is desirable to improve the mechanical robustness of the cover window.

It is to be understood that this background of the technology section is, in part, intended to provide useful background for understanding the technology. However, this background of the technology section may also include ideas, concepts, or recognitions that were not part of what was known or appreciated by those skilled in the pertinent art prior to a corresponding effective filing date of the subject matter disclosed herein.

### SUMMARY

An embodiment of the disclosure provides a cover window with improved mechanical robustness and a display device including the cover window.

An embodiment of the disclosure provides a fabrication method capable of improving mechanical robustness of a cover window.

According to an embodiment of the disclosure, a cover window may include a polymer film, a printing layer disposed below the polymer film, and a hard coating layer including a first portion disposed on a top surface of the polymer film and overlapping the polymer film, a second portion disposed on a bottom surface of the printing layer and overlapping the printing layer, and a third portion disposed between the first portion and the second portion. An area of the second portion may be smaller than an area of the printing layer in plan view.

In an embodiment, the third portion may contact a side surface of the polymer film and a side surface of the printing layer.

In an embodiment, the third portion may extend from an end of the first portion.

In an embodiment, an edge of the polymer film may overlap an edge of the printing layer.

In an embodiment, the polymer film may include a first polymer film having a first hardness, and a second polymer film having a second hardness greater than the first hardness, the second polymer film being disposed on the first polymer film.

In an embodiment, the first polymer film may include polycarbonate, and the second polymer film may include poly methyl methacrylate.

In an embodiment, the second polymer film may include a compound including fluorine.

In an embodiment, the polymer film may further include a third polymer film, having a third hardness greater than the first hardness, the third polymer film being disposed below the first polymer film.

In an embodiment, a thickness of the hard coating layer may range from about 5 μm to about 50 μm.

In an embodiment, the cover window may further include a sub-coating layer disposed between the polymer film and the printing layer. A hardness of the sub-coating layer may be less than a hardness of the hard coating layer.

In an embodiment, the cover window may further include a sub-coating layer disposed between the polymer film and the printing layer. A thickness of the sub-coating layer may be less than a thickness of the hard coating layer.

According to an embodiment of the disclosure, a method of fabricating a cover window may include providing a polymer film, providing a printing layer on a bottom surface of the polymer film, removing an edge portion of the polymer film, wherein the edge portion of the polymer film may not overlap the printing layer, and providing a coating solution on a top surface of the polymer film to form a hard coating layer. The hard coating layer may include a first portion disposed on the top surface of the polymer film and overlapping the polymer film, a second portion disposed on a bottom surface of the printing layer and overlapping the printing layer, and a third portion disposed between the first portion and the second portion. An area of the second portion may be smaller than an area of the printing layer, in plan view.

In an embodiment, the removing of the edge portion of the polymer film may include removing the polymer film such that an edge of the polymer film may overlap an edge of the printing layer.

In an embodiment, the providing of the polymer film may include providing a first polymer film having a first hardness, and providing a second polymer film having a second hardness, which may be greater than the first hardness.

In an embodiment, the providing of the polymer film may further include forming a sub-coating layer below the polymer film.

In an embodiment, the forming of the hard coating layer may include diffusing the coating solution from the top surface of the polymer film to the bottom surface of the printing layer.

In an embodiment, the coating solution may include a solid ingredient, and a content of the solid ingredient may be in a range from about 30 wt % to about 50 wt %.

In an embodiment, the coating solution may include at least one of methanol, isopropyl alcohol, isopropyl ether, acetone, methyl ethyl ketone, and propylene glycol methyl ether acetate.

According to an embodiment of the disclosure, a display device may include a display panel, and a cover window disposed on the display panel. The cover window may include a polymer film, a printing layer disposed below the polymer film, and a hard coating layer including a first portion disposed on a top surface of the polymer film and overlapping the polymer film, a second portion disposed on a bottom surface of the printing layer and overlapping the printing layer, and a third portion disposed between the first portion and the second portion. An area of the second portion may be smaller than an area of the printing layer in plan view.

In an embodiment, the third portion may contact a side surface of the polymer film and a side surface of the printing layer.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1A is a perspective view schematically illustrating a display device according to an embodiment of the disclosure.

FIG. 1B is a perspective view schematically illustrating a display device according to an embodiment of the disclosure.

FIG. 2 is a schematic sectional view taken along line I-I′ of FIG. 1A.

FIG. 3 is a sectional view schematically illustrating a cover window according to an embodiment of the disclosure.

FIG. 4 is an exploded perspective view schematically illustrating a portion of a cover window according to an embodiment of the disclosure.

FIG. 5 is a sectional view schematically illustrating a display device according to an embodiment of the disclosure.

FIG. 6 is a sectional view schematically illustrating a cover window according to an embodiment of the disclosure.

FIG. 7 is a sectional view schematically illustrating a portion of a cover window according to an embodiment of the disclosure.

FIG. 8 is a sectional view schematically illustrating a portion of a cover window according to an embodiment of the disclosure.

FIG. 9 is a sectional view schematically illustrating a portion of a cover window according to an embodiment of the disclosure.

FIG. 10 is a flow chart schematically illustrating a method of fabricating a cover window, according to an embodiment of the disclosure.

FIG. 11 is a sectional view schematically illustrating a method of fabricating a cover window, according to an embodiment of the disclosure.

FIG. 12 is a sectional view schematically illustrating a method of fabricating a cover window, according to an embodiment of the disclosure.

FIG. 13 is a sectional view schematically illustrating a method of fabricating a cover window, according to an embodiment of the disclosure.

FIG. 14 is a sectional view schematically illustrating a method of fabricating a cover window, according to an embodiment of the disclosure.

It should be noted that these figures are intended to illustrate the general characteristics of methods, structure and/or materials utilized in certain example embodiments and to supplement the written description provided below. These drawings may not be, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

Example embodiments of the disclosure will now be described more fully with reference to the accompanying drawings, in which example embodiments are shown. Example embodiments of the disclosure may, however, be embodied in many different forms and should not be construed as being limited to the embodiments set forth herein. Rather, these embodiments are provided so that this disclosure will be thorough and complete, and will fully convey the concept of example embodiments to those of ordinary skill in the art. In the drawings, the thicknesses of layers and regions may be exaggerated for clarity. Like reference numerals in the drawings denote like elements, and thus their description will be omitted.

It will be understood that the terms “connected to” or “coupled to” may include a physical or electrical connection or coupling. It will be understood that when an element is referred to as being “connected” or “coupled” to another element, it can be directly connected or coupled to the other element or intervening elements may be present. In contrast, when an element is referred to as being “directly connected” or “directly coupled” to another element, there may be no intervening elements present. Other words used to describe the relationship between elements or layers should be interpreted in a like fashion (e.g., “between” versus “directly between,” “adjacent” versus “directly adjacent,” “on” versus “directly on”).

Like numbers indicate like elements throughout. As used herein the term “and/or” includes any and all combinations of one or more of the associated listed items. For example, “A and/or B” may be understood to mean “A, B, or A and B.” The terms “and” and “or” may be used in the conjunctive or disjunctive sense and may be understood to be equivalent to “and/or.” In the specification and the claims, the phrase “at least one of” is intended to include the meaning of “at least one selected from the group of” for the purpose of its meaning and interpretation. For example, “at least one of A and B” may be understood to mean “A, B, or A and B.”

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” may be intended to include the plural forms as well (and vice versa), unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the disclosure are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the disclosure should not be construed as limited to the particular shapes of regions illustrated herein but are to include deviations in shapes that result, for example, from manufacturing.

The terms “overlap” or “overlapped” mean that a first object may be above or below or to a side of a second object, and vice versa. Additionally, the term “overlap” may include layer, stack, face or facing, extending over, extending under, covering, or partly covering or any other suitable term as would be appreciated and understood by those of ordinary skill in the art. The terms “face” and “facing” mean that a first element may directly or indirectly oppose a second element. In a case in which a third element intervenes between the first and second element, the first and second element may be understood as being indirectly opposed to one another, although still facing each other. When an element is described as ‘not overlapping’ or ‘to not overlap’ another element, this may include that the elements are spaced apart from each other, offset from each other, or set aside from each other or any other suitable term as would be appreciated and understood by those of ordinary skill in the art.

“About”, “approximately”, substantially, and the like, as used herein are inclusive of the stated value and mean within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which example embodiments of the disclosure belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

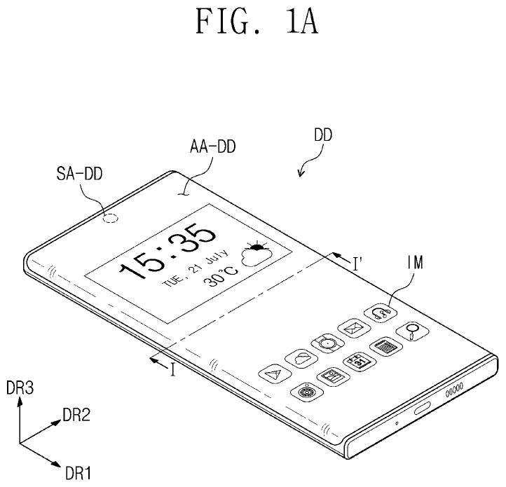

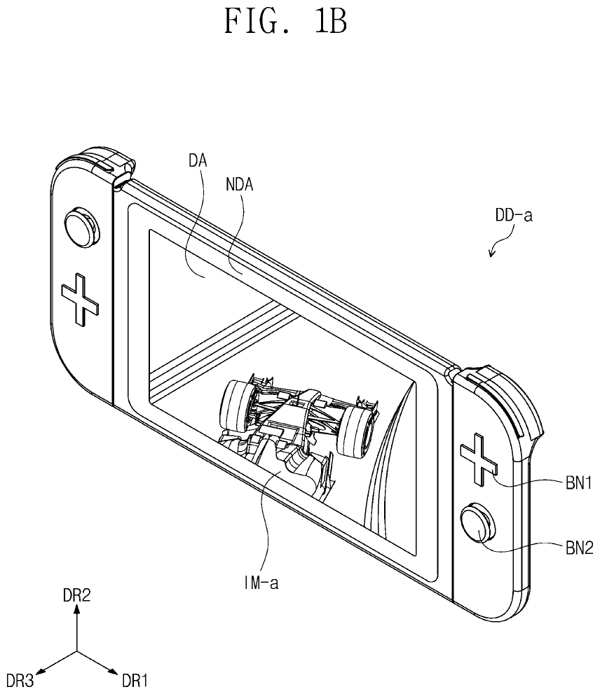

FIGS. 1A and 1B are perspective views schematically illustrating a display device according to an embodiment of the disclosure. A display device DD or DD-a according to an embodiment of the disclosure may be a device that may be activated by an electrical signal applied thereto. For example, the display device DD or DD-a may be a cellular phone, a tablet, a car navigation system, a gaming machine, or a wearable device but is not limited to these examples. FIG. 1A illustrates an example, in which the display device DD may be a cellular phone.

Referring to FIG. 1A, the display device DD may include an active region AA-DD, which may be used to display an image IM. The active region AA-DD may include a flat surface defined by a first direction axis DR1 and a second direction axis DR2. The active region AA-DD may further include a curved surface which may be bent or curvedly extended from at least one side edge of the flat surface defined by the first and second direction axes DR1 and DR2. The display device DD of FIG. 1A illustrates an example, in which the display device DD has two curved surfaces that may be extended from opposite side surfaces of the flat surface. However, the shape of the active region AA-DD is not limited to this example. In an embodiment, the active region AA-DD may have only the flat surface. In other embodiments, the active region AA-DD may have four curved surfaces that may be respectively extended from four side surfaces of the flat surface.

In an embodiment, the display device DD may be flexible. Here, the term “flexible” will be used to express that the display device DD may be highly bendable or foldable enough to have a curvature radius from several angstroms to several centimeters. For example, the display device DD may be a foldable display device. In other embodiments, the display device DD may be a rigid display device.

A thickness direction of the display device DD may be parallel to a third direction axis DR3, which may be normal to the flat surface defined by the first and second direction axes DR1 and DR2. In the specification, directions indicated by the first to third direction axes DR1, DR2, and DR3 may be relative concept, and in an embodiment, they may be changed to indicate other directions. Directions indicated by the first to third direction axes DR1, DR2, and DR3 may be referred to as first to third directions and will be identified with the same reference numbers. In the specification, the first and second direction axes DR1 and DR2 may be perpendicular to each other, and the third direction axis DR3 may be a normal direction that may be perpendicular to the flat surface defined by the first and second direction axes DR1 and DR2.

A sensing region SA-DD may be defined in the active region AA-DD of the display device DD. FIG. 1A illustrates an example in which one sensing region SA-DD may be provided, but the number of sensing regions SA-DD is not limited to one. The sensing region SA-DD may be a part of the active region AA-DD. The display device DD may display an image through the sensing region SA-DD.

Unlike the example of FIG. 1A, FIG. 1B illustrates an example in which a gaming machine may be used as the display device DD-a. The display device DD-a may include a display region DA and a non-display region NDA, which may be provided adjacent to the display region DA. The display region DA may display an image IM-a. The display region DA may include a flat surface defined by the first and second direction axes DR1 and DR2. The non-display region NDA may be enclosed by the display region DA. The shapes of the display and non-display regions DA and NDA may be variously changed in a mutually influential manner.

Buttons BN1 and BN2 may be disposed in the non-display region NDA. The buttons BN1 and BN2 may be used to manipulate the display device DD-a. In an embodiment, at least one first button BN1 and at least one second button BN2 may be provided in the display device DD-a. In other embodiments, one of the first and second buttons BN1 and BN2 may be omitted. The first button BN1 may have a cross shape, and the second button BN2 may have a circular shape. However, the disclosure is not limited to this example, and the shapes of the buttons BN1 and BN2 may be variously changed. The buttons BN1 and BN2 may be disposed in the display region DA, unlike the structure illustrated in the drawings. The technical features of the display device DD or DD-a to be described below may be equally applied to the display device DD of FIG. 1A and the display device DD-a of FIG. 1B.

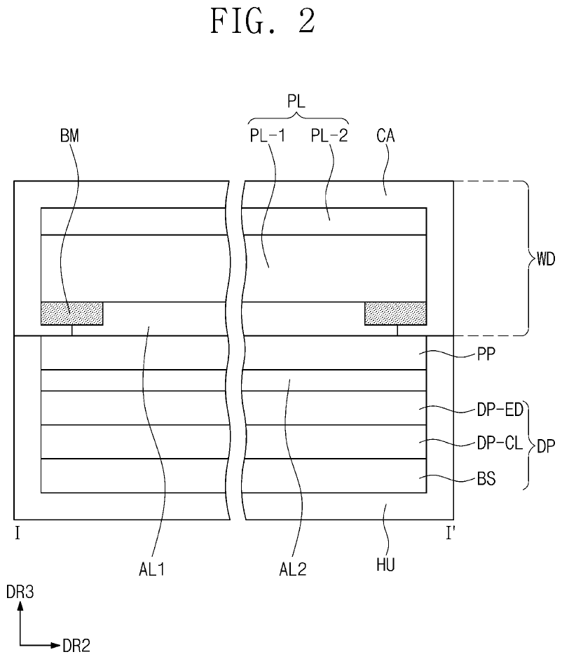

FIG. 2 is a schematic sectional view, which is taken along line I-I′ of FIG. 1A to illustrate the display device DD or DD-a according to an embodiment of the disclosure. The display device DD or DD-a may include a display panel DP and a cover window WD, which may be disposed on the display panel DP. The display device DD or DD-a may include a housing HU disposed below the display panel DP. The display panel DP may be placed in the housing HU.

The display panel DP may include a base layer BS, a circuit layer DP-CL disposed on the base layer BS, and an emission element layer DP-ED disposed on the circuit layer DP-CL.

The base layer BS may be a glass substrate, a metal substrate, a plastic substrate, or a combination thereof. However, the disclosure is not limited to this example, and the base layer BS may be an inorganic layer, an organic layer, or a layer made of a composite material.

The circuit layer DP-CL may be disposed on the base layer BS and may include transistors (not shown). Each of the transistors (not shown) may include a control electrode, an input electrode, and an output electrode. For example, the circuit layer DP-CL may include a switching transistor and a driving transistor, which may be used to operate or drive emission elements (not shown) of the emission element layer DP-ED.

The emission element layer DP-ED may include emission elements. Each of the emission elements may include a first electrode and a second electrode, which may be disposed to face each other, and a light emitting layer, which may be disposed between the first and second electrodes. Although not shown, an encapsulation layer may be disposed on the emission element layer DP-ED, and in an embodiment, the encapsulation layer may be provided to hermetically seal the emission element layer DP-ED.

An optical layer PP may be disposed between the display panel DP and the cover window WD. The optical layer PP may be disposed on the display panel DP to control a light reflection issue on the display panel DP caused by an external light. For example, the optical layer PP may include a polarization layer or a color filter layer. However, the disclosure is not limited to this example and, in an embodiment, the optical layer PP may be omitted.

Adhesive layers AL1 and AL2 may be disposed between the display panel DP and the optical layer PP and between the optical layer PP and the cover window WD. The adhesive layers AL1 and AL2 may be optically transparent. The adhesive layers AL1 and AL2 may be formed of or include at least one of optically clear adhesive (OCA), optically clear resin (OCR), and pressure sensitive adhesive (PSA). The optical layer PP and the cover window WD may be coupled to each other by a first adhesive layer AL1. The display panel DP and the optical layer PP may be coupled to each other by a second adhesive layer AL2. In an embodiment, although not shown, at least one of the first and second adhesive layers AL1 and AL2 may be omitted.

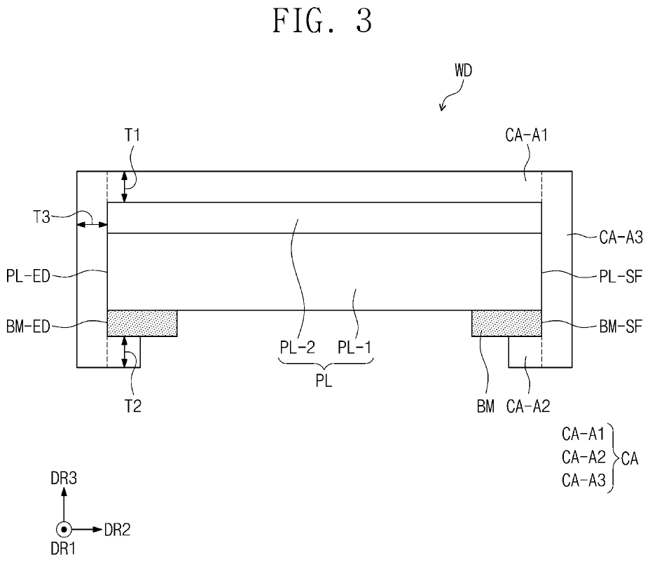

FIG. 3 is a sectional view schematically illustrating a cover window (e.g., a detailed structure of the cover window WD of FIG. 2) according to an embodiment of the disclosure. Referring to FIG. 3, the cover window WD according to an embodiment of the disclosure may include a polymer film PL, a printing layer BM, and a hard coating layer CA.

The polymer film PL may include a first polymer film PL-1 and a second polymer film PL-2, which may be disposed on the first polymer film PL-1. The first polymer film PL-1 may have a first hardness, and the second polymer film PL-2 may have a second hardness. The second hardness may be greater than the first hardness. The second polymer film PL-2, which may be placed at a higher level in the thickness direction, may have hardness greater than the first polymer film PL-1 at a lower level. A modulus of the second polymer film PL-2 may be greater than a modulus of the first polymer film PL-1. A thickness of the first polymer film PL-1 may be greater than a thickness of the second polymer film PL-2. However, the disclosure is not limited to this example, and the hardness, modulus, and thickness of at least one of the first and second polymer films PL-1 or PL-2 may be variously changed.

In an embodiment, the first polymer film PL-1 may be formed of or include polycarbonate (PC), and the second polymer film PL-2 may be formed of or include poly methyl methacrylate (PMMA). Furthermore, the second polymer film PL-2 may further include a fluorine-including compound. The second polymer film PL-2 may further include a material that may be used to realize an anti-fingerprint function. However, the disclosure is not limited to this example, and the materials for the first and second polymer films PL-1 and PL-2 are not limited thereto.

In an embodiment, one of the first and second polymer films PL-1 and PL-2 may be omitted. The polymer film PL may be a single layer that may be made of a single material or several materials. For example, the polymer film PL may be formed of or include at least one of polyimide (PI), polyethylene terephthalate (PET), polyurethane (PU), and triacetyl cellulose (TAC). The polymer film PL may be optically transparent.

The printing layer BM may be disposed below the polymer film PL. An edge PL-ED of the polymer film PL may overlap an edge BM-ED of the printing layer BM. The edge PL-ED of the polymer film PL and the edge BM-ED of the printing layer BM may be parallel to the third direction axis DR3.

The printing layer BM may be disposed adjacent to the first polymer film PL-1. The printing layer BM may be disposed below the first polymer film PL-1. The second polymer film PL-2 and the printing layer BM may be spaced apart from each other with the first polymer film PL-1 interposed therebetween. The printing layer BM may be formed to include an organic or inorganic light-blocking material which includes black pigment or dye. However, the disclosure is not limited to this example, and the printing layer BM may be provided to have a non-black color.

In an embodiment, the hard coating layer CA may include at least two portions, which may be located near the printing layer BM and the polymer film PL, respectively. The hard coating layer CA may include a first portion CA-A1, a second portion CA-A2, and a third portion CA-A3. The first portion CA-A1, the second portion CA-A2, and the third portion CA-A3 of the hard coating layer CA may be provided as a single object. The first portion CA-A1, the second portion CA-A2, and the third portion CA-A3 of the hard coating layer CA may be formed by a single process.

The first portion CA-A1 of the hard coating layer CA may be disposed on a top surface of the polymer film PL. The first portion CA-A1 may be an element that may fully overlap the top surface of the polymer film PL. The first portion CA-A1 of the hard coating layer CA may cover the top surface of the polymer film PL. More specifically, the first portion CA-A1 of the hard coating layer CA may cover a top surface of the second polymer film PL-2. In other embodiments, in the case where the second polymer film PL-2 is omitted, the hard coating layer CA may be provided to cover a top surface of the first polymer film PL-1. When viewed in a sectional view, the first portion CA-A1 may be extended in a direction parallel to the second direction axis DR2.

When viewed in a sectional view, the second portion CA-A2 of the hard coating layer CA may be extended in a direction parallel to the second direction axis DR2. When viewed in a plan view, the first portion CA-A1 and the second portion CA-A2 may be parallel to the flat surface defined by the first and second direction axes DR1 and DR2. The second portion CA-A2 of the hard coating layer CA may be disposed on a bottom surface of the printing layer BM. The second portion CA-A2 of the hard coating layer CA may cover at least a portion of the printing layer BM. The second portion CA-A2 of the hard coating layer CA may be in contact with the bottom surface of the printing layer BM. The second portion CA-A2 may overlap at least a portion of the bottom surface of the printing layer BM. The bottom surface of the printing layer BM and the top surface of the printing layer BM may be spaced apart from each other in a direction parallel to the third direction axis DR3. The top surface of the printing layer BM may be adjacent to the polymer film PL.

The third portion CA-A3 of the hard coating layer CA may be disposed between the first portion CA-A1 and the second portion CA-A2. An end of the third portion CA-A3 may be placed adjacent to the first portion CA-A1, and an opposite end of the third portion CA-A3 may be placed adjacent to the second portion CA-A2. The third portion CA-A3 may be an element that may be extended from an end of the first portion CA-A1. The second portion CA-A2 may be extended from the third portion CA-A3. The third portion CA-A3 may be extended in a direction parallel to the third direction axis DR3. The third portion CA-A3 may cover a side surface PL-SF of the polymer film PL and a side surface BM-SF of the printing layer BM. The third portion CA-A3 may be in contact with the side surface PL-SF of the polymer film PL and the side surface BM-SF of the printing layer BM.

The hard coating layer CA may have a hardness that may be greater than the polymer film PL. A modulus of the hard coating layer CA may be higher than a modulus of the polymer film PL. More specifically, the modulus of the hard coating layer CA may be greater than the modulus of the first polymer film PL-1 and the modulus of the second polymer film PL-2.

The third portion CA-A3 may be used to improve the mechanical robustness of the side surface of the cover window WD. The hard coating layer CA may cover the polymer film PL and at least a portion of the printing layer BM. The second portion CA-A2 of the hard coating layer CA may protect the printing layer BM. In case that an external impact is exerted on the printing layer BM placed below the polymer film PL, the printing layer BM may be delaminated from the polymer film PL. In the case where the external impact is exerted on the printing layer BM that may be disposed adjacent to the first polymer film PL-1 whose hardness may be smaller than the second polymer film PL-2, the printing layer BM may be delaminated from the polymer film PL. The second portion CA-A2 may protect the printing layer BM from the external impact. Since the second portion CA-A2 may be provided to cover at least a portion of the printing layer BM, it may be possible to prevent the printing layer BM from being delaminated from the polymer film PL.

The third portion CA-A3 may be provided to cover the side surface PL-SF of the polymer film PL, and thus, the third portion CA-A3 may protect the polymer film PL from an external impact. An exposed area of the side surface PL-SF of the polymer film PL may be larger in the first polymer film PL-1 than in the second polymer film PL-2. As described above, since the thickness of the first polymer film PL-1 may be greater than the thickness of the second polymer film PL-2, the first polymer film PL-1 may be exposed in a relatively larger area. Since the first polymer film PL-1 may have a smaller hardness than the second polymer film PL-2, the first polymer film PL-1 may be easily broken by an external impact. Since the side surface PL-SF of the polymer film PL may be covered with the third portion CA-A3 of the hard coating layer CA, the polymer film PL may be protected from the external impact. Accordingly, the cover window WD according to an embodiment of the disclosure may have an improved mechanical robustness property. This may make it possible to improve the reliability of the display device DD or DD-a including the cover window WD.

In an embodiment, the hard coating layer CA may have thicknesses T1, T2, and T3 that range from about 5 μm to about 50 μm. In the case where the thickness of the hard coating layer is smaller than about 5 μm, it may be difficult to improve mechanical robustness of the cover window. By contrast, in the case where the thickness of the hard coating layer is larger than about 50 μm, the cover window may have a significantly increased thickness, and the display device may also have an increased thickness.

The thickness T1 of the first portion CA-A1 and the thickness T2 of the second portion CA-A2 may be values that may be measured in a direction parallel to the third direction axis DR3. The thickness T3 of the third portion CA-A3 may be a value that may be measured in a direction parallel to the second direction axis DR2. The thickness T1 of the first portion CA-A1 may range from about 5 μm to about 50 μm. The thickness T2 of the second portion CA-A2 may range from about 5 μm to about 50 μm. The thickness T3 of the third portion CA-A3 may range from about 5 μm to about 50 μm. The thickness T1 of the first portion CA-A1, the thickness T2 of the second portion CA-A2, and the thickness T3 of the third portion CA-A3 may have a same value. In other embodiments, at least one of the thickness T1 of the first portion CA-A1, the thickness T2 of the second portion CA-A2, and the thickness T3 of the third portion CA-A3 may be different from the others. Even in this case, such a difference between the thicknesses may be within a measurement error range.

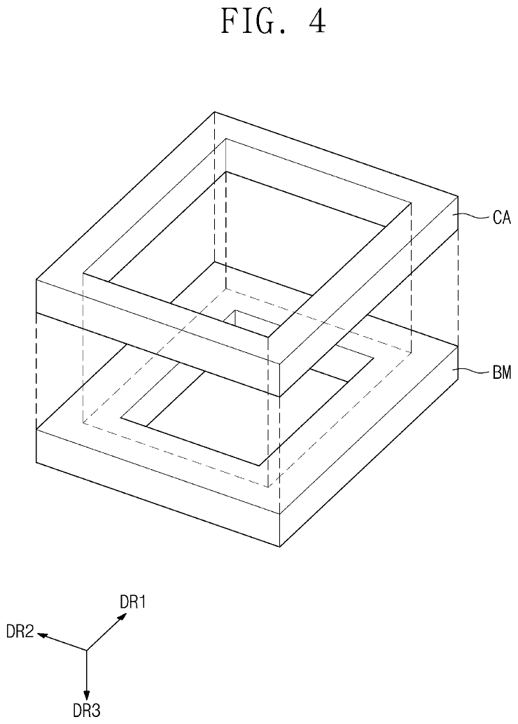

FIG. 4 is an exploded perspective view schematically illustrating the hard coating layer CA and the printing layer BM, and in order to reduce complexity in the drawings and to provide better understanding of example embodiments of the disclosure, the hard coating layer CA is illustrated to have only the second portion CA-A2 in contact with the printing layer BM. On the flat surface defined by the first and second direction axes DR1 and DR2, an area of the second portion CA-A2 of the hard coating layer CA may be smaller than or equal to an area of the printing layer BM. On the flat surface defined by the first and second direction axes DR1 and DR2, the area of the second portion CA-A2 may be equal to the area of the printing layer BM. In other embodiments, on the flat surface defined by the first and second direction axes DR1 and DR2, the area of the second portion CA-A2 may be smaller than the area of the printing layer BM. For example, on the flat surface defined by the first and second direction axes DR1 and DR2, the area of the second portion CA-A2 may range from about 10% to about 90% of the area of the printing layer BM. More specifically, on the flat surface defined by the first and second direction axes DR1 and DR2, the area of the second portion CA-A2 may be about 50% of the area of the printing layer BM. In the case where the area of the second portion CA-A2 is within the range of about 10% to about 90% of the area of the printing layer BM, the hard coating layer CA may not be recognized through the active region AA-DD (e.g., see FIG. 1A) and may protect the printing layer BM from an external impact. However, the disclosure is not limited to this example, and a ratio of the area of the second portion CA-A2 to the area of the printing layer BM may be variously changed.

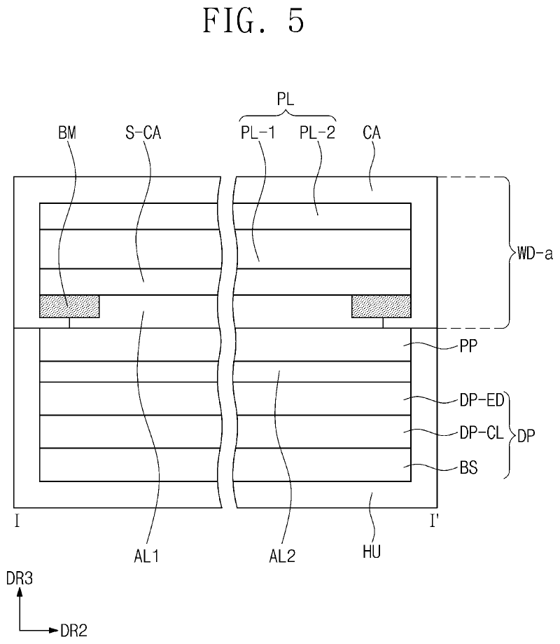

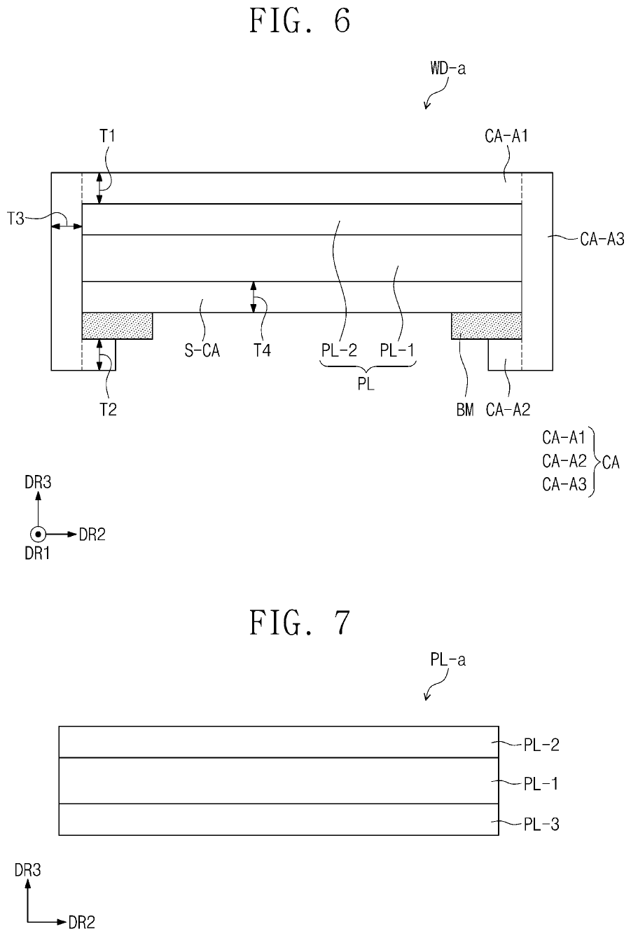

FIG. 5 schematically illustrates another example of the cover window, and FIG. 6 illustrates a detailed structure of the cover window of FIG. 5. Unlike the structure shown in FIGS. 2 and 3, the cover window of FIGS. 5 and 6 may further include a sub-coating layer.

According to an embodiment, a sub-coating layer S-CA may be disposed between the polymer film PL and the printing layer BM. The sub-coating layer S-CA may be disposed below the polymer film PL. The sub-coating layer S-CA may be an element whose hardness may be lower than that of the hard coating layer CA. The hardness of the sub-coating layer S-CA may be smaller than the hardness of the hard coating layer CA. The hard coating layer CA, which may be placed at a higher level in the thickness direction, may have hardness that may be greater than the sub-coating layer S-CA. The hardness of the hard coating layer CA, which may be placed at an upper level of the display device DD or DD-a, may be greater than the hardness of the sub-coating layer S-CA. In other embodiments, the hardness of the sub-coating layer S-CA may be equal to the hardness of the hard coating layer CA.

A thickness T4 of the sub-coating layer S-CA may be smaller than or equal to the thicknesses T1, T2, and T3 of the hard coating layer CA. The thickness T4 of the sub-coating layer S-CA may be smaller than the thicknesses T1, T2, and T3 of the hard coating layer CA. The thickness T4 of the sub-coating layer S-CA may be smaller than at least one of the thickness T1 of the first portion CA-A1, the thickness T2 of the second portion CA-A2, and the thickness T3 of the third portion CA-A3. In other embodiments, the thickness T4 of the sub-coating layer S-CA may be equal to the thicknesses T1, T2, and T3 of the hard coating layer CA. The thickness T4 of the sub-coating layer S-CA may be equal to at least one of the thickness T1 of the first portion CA-A1, the thickness T2 of the second portion CA-A2, and the thickness T3 of the third portion CA-A3. The thickness T4 of the sub-coating layer S-CA may be equal to all of the thickness T1 of the first portion CA-A1, the thickness T2 of the second portion CA-A2, and the thickness T3 of the third portion CA-A3.

In an embodiment, the hard coating layer CA may be formed of or include at least one of organic compounds and organic/inorganic composite compounds. The organic compounds may include acrylic compounds, epoxy compounds, or combinations thereof, and organic/inorganic compounds may include silicon compounds.

FIGS. 7-9 are sectional views schematically illustrating some examples of the polymer film according to an embodiment of the disclosure. In an embodiment, three or more polymer films PL-a, PL-b, and PL-c may be provided in the stacked form. The polymer films PL-a, PL-b, and PL-c may further include one or more polymer films, in addition to the first and second polymer films PL-1 and PL-2. In the following description of FIGS. 7-9, the same polymer film may be identified by the same reference number without repeating an overlapping description thereof. The polymer films PL-a, PL-b, and PL-c of FIGS. 7-9 may have substantially the same features as the polymer film PL of FIGS. 3 and 6.

Referring to FIG. 7, the polymer film PL-a may include first to third polymer films PL-1, PL-2, and PL-3. The third polymer film PL-3 may be disposed below the first polymer film PL-1. The third polymer film PL-3, the first polymer film PL-1, the second polymer film PL-2 may be sequentially stacked on each other. The third polymer film PL-3 may have a third hardness that may be greater than the first hardness of the first polymer film PL-1. A thickness of the third polymer film PL-3 may be smaller than the thickness of the first polymer film PL-1. The third polymer film PL-3 may protect the first polymer film PL-1. Since the third polymer film PL-3 may have a greater hardness than the first polymer film PL-1, the third polymer film PL-3 may have an impact resistant property that may be better than the first polymer film PL-1. The printing layer BM may be disposed below the third polymer film PL-3. The sub-coating layer S-CA may be disposed between the third polymer film PL-3 and the printing layer BM. In other embodiments, the sub-coating layer S-CA may be omitted between the third polymer film PL-3 and the printing layer BM. For example, the third polymer film PL-3 and the second polymer film PL-2 may be formed of or include a same material. The third polymer film PL-3 and the second polymer film PL-2 may be formed of or include poly methyl methacrylate.

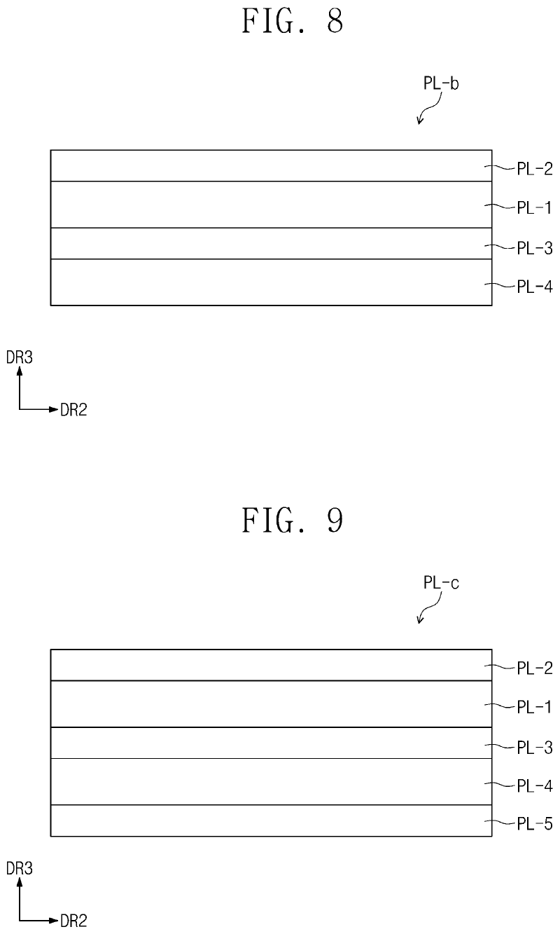

The polymer film PL-b of FIG. 8 may further include the third polymer film PL-3 and a fourth polymer film PL-4. The third polymer film PL-3 may be disposed below the first polymer film PL-1, and the fourth polymer film PL-4 may be disposed below the third polymer film PL-3. The fourth polymer film PL-4 and the first polymer film PL-1 may be spaced apart from each other with the third polymer film PL-3 interposed therebetween. The printing layer BM may be disposed below the fourth polymer film PL-4, and the sub-coating layer S-CA may be disposed between the fourth polymer film PL-4 and the printing layer BM. In other embodiments, the sub-coating layer S-CA may be omitted from a region between the fourth polymer film PL-4 and the printing layer BM. The fourth polymer film PL-4 may have a fourth hardness, and the fourth hardness of the fourth polymer film PL-4 may be smaller than the third hardness of the third polymer film PL-3. A thickness of the fourth polymer film PL-4 may be greater than the thickness of the third polymer film PL-3. The fourth polymer film PL-4 and the first polymer film PL-1 may be formed of or include a same material. For example, the fourth polymer film PL-4 and the first polymer film PL-1 may be formed of or include polycarbonate.

The polymer film PL-c of FIG. 9 may further include the third polymer film PL-3, the fourth polymer film PL-4, and a fifth polymer film PL-5. The fifth polymer film PL-5 may be disposed below the fourth polymer film PL-4. The fifth polymer film PL-5, the fourth polymer film PL-4, the third polymer film PL-3, the first polymer film PL-1, and the second polymer film PL-2 may be sequentially stacked on each other. The printing layer BM may be disposed below the fifth polymer film PL-5. The sub-coating layer S-CA may be disposed between the fifth polymer film PL-5 and the printing layer BM. In other embodiments, the sub-coating layer S-CA may be omitted.

The fifth polymer film PL-5 may have a fifth hardness, and the fifth hardness of the fifth polymer film PL-5 may be greater than the fourth hardness of the fourth polymer film PL-4. A thickness of the fifth polymer film PL-5 may be smaller than the thickness of the fourth polymer film PL-4. The fifth polymer film PL-5 may protect the fourth polymer film PL-4. Since the fifth polymer film PL-5 may have a greater hardness than the fourth polymer film PL-4, the fifth polymer film PL-5 may have an impact resistant property that may be better than the fourth polymer film PL-4. For example, the fifth polymer film PL-5 and the third polymer film PL-3 may be formed of or include a same material. The fifth polymer film PL-5 and the third polymer film PL-3 may be formed of or include poly methyl methacrylate.

In an embodiment, the display device DD or DD-a may include the display panel DP and the cover window WD or WD-a provided on the display panel DP. The cover window WD or WD-a may include the polymer film PL, the printing layer BM, and the hard coating layer CA. The hard coating layer CA may be provided to cover the polymer film PL and at least a portion of the printing layer BM and thereby to protect the polymer film PL and the printing layer BM from an external impact. Accordingly, the cover window WD or WD-a may exhibit an improved hardness or strength property. This may make it possible to improve the reliability of the display device DD or DD-a.

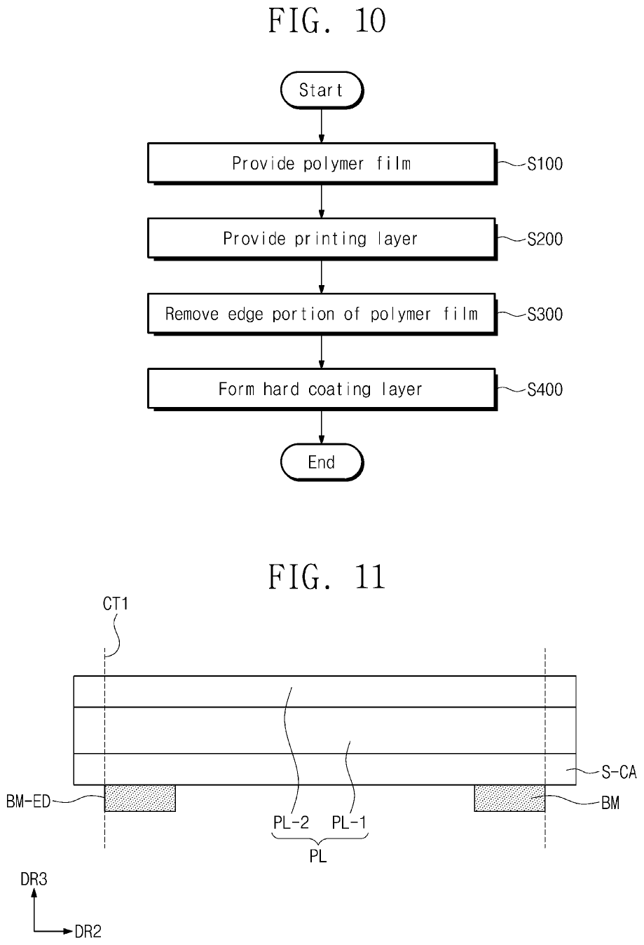

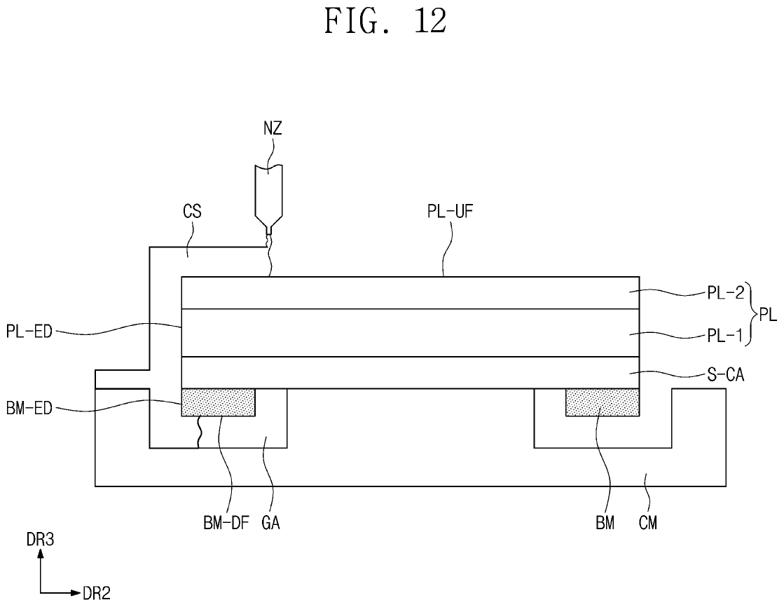

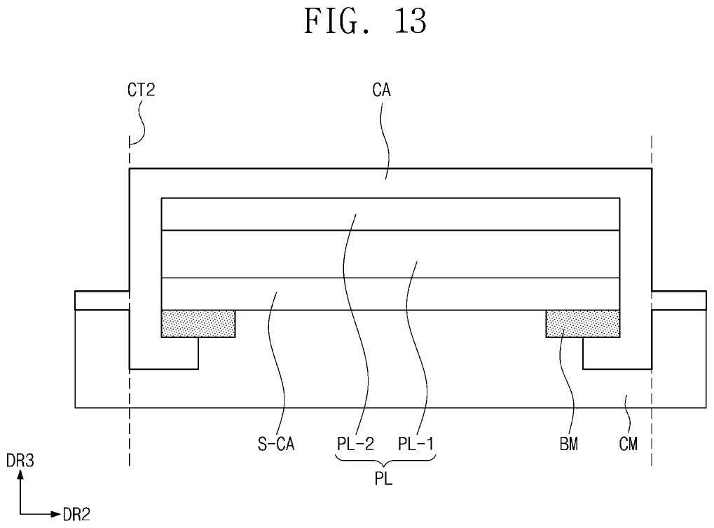

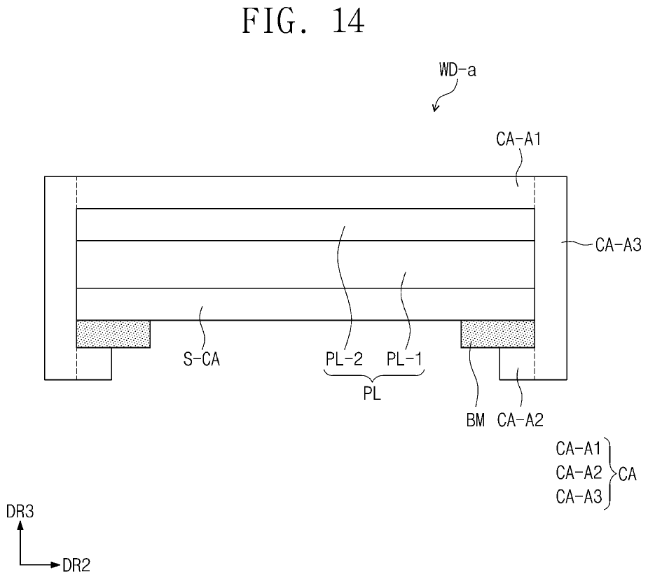

FIG. 10 is a flow chart schematically illustrating a method of fabricating a cover window, according to an embodiment of the disclosure. FIGS. 11-14 schematically illustrate a process of fabricating a cover window according to an embodiment of the disclosure. In the following description of FIGS. 10-14, an element previously described with reference to FIGS. 2 to 9 may be identified by the same reference number without repeating an overlapping description thereof, for the sake of brevity.

According to an embodiment of the disclosure, a method of fabricating a cover window may include providing a polymer film (in S100), providing a printing layer (in S200), removing an edge portion of the polymer film (in S300), and forming a hard coating layer (in S400).

The polymer film PL may include the first polymer film PL-1 and the second polymer film PL-2, which may be disposed on the first polymer film PL-1. The first hardness of the first polymer film PL-1 may be smaller than the second hardness of the second polymer film PL-2. In an embodiment, the providing of the polymer film (in S100) may include forming the sub-coating layer S-CA below the polymer film PL. The sub-coating layer S-CA may be formed by providing a sub-coating solution onto a bottom surface of the polymer film PL. In an embodiment, the formation of the sub-coating layer S-CA may be omitted.

The printing layer BM may be provided below the polymer film PL. For example, the printing layer BM may be formed by providing an organic or inorganic light-blocking material including black pigment or dye onto a bottom surface of the polymer film PL. The printing layer BM may be formed through a printing process. However, the disclosure is not limited to this example, and the printing layer BM may be formed of various materials or may be formed by various methods.

A portion of the polymer film PL may be removed. For example, an edge portion of the polymer film PL, which may not overlap the printing layer BM, may be removed. Referring to FIG. 11, the removal of the edge portion of the polymer film PL may be performed such that a new edge of the polymer film PL may be aligned to the edge BM-ED of the printing layer BM. For example, the edge portion of the polymer film PL may be removed along a first processing line CT1 that may be parallel to the edge BM-ED of the printing layer BM. The first processing line CT1 may be parallel to the thickness direction. The edge portion of the polymer film PL may be removed through a computer numerical control (CNC) process. An edge portion of the sub-coating layer S-CA, which may be located below the polymer film PL, may also be removed. After the partial removal of the polymer film PL, the edge PL-ED of the polymer film PL may be overlapped or aligned to the edge BM-ED of the printing layer BM. The edge PL-ED of the polymer film PL and the edge BM-ED of the printing layer BM may be parallel to the thickness direction.

After the removing of the edge portion of the polymer film PL (in S300), the forming of the hard coating layer (in S400) may be performed. A coating solution CS may be provided on a top surface PL-UF of the polymer film PL. The coating solution CS may be provided through a nozzle NZ (e.g., a slot die). In other embodiments, the coating solution CS may be provided by a spray or inkjet process. However, the disclosure is not limited to this example, and the method of providing the coating solution CS may be variously changed.

The coating solution CS may cover at least a portion of a bottom surface BM-DF of the printing layer BM. The coating solution CS may cover the top surface PL-UF of the polymer film PL, the side surface PL-SF (e.g., FIG. 3) of the polymer film PL, and the side surface BM-SF (e.g., FIG. 3) of the printing layer BM. The coating solution CS may be transferred to the bottom surface BM-DF of the printing layer BM.

A protection film CM may be provided below the printing layer BM to protect the polymer film PL and the printing layer BM. The protection film CM may be removed after the fabrication process.

In an embodiment, the protection film CM may be provided to be in contact with a portion of the printing layer BM. Furthermore, the protection film CM may be in contact with a portion of the sub-coating layer S-CA. In the case where the sub-coating layer S-CA is omitted, the protection film CM may be in contact with a portion of the polymer film PL. For example, the protection film CM may be in contact with a portion of the first polymer film PL-1. In an embodiment, the protection film CM may be provided to form a space GA between the protection film CM and the bottom surface BM-DF of the printing layer BM. Accordingly, the coating solution CS may be supplied into the space GA between the protection film CM and the printing layer BM. For example, the coating solution CS may be transferred from the top surface PL-UF of the polymer film PL to the bottom surface BM-DF of the printing layer BM.

The coating solution CS may be transferred to cover at least a portion of the bottom surface BM-DF of the printing layer BM. The transferred coating solution CS may form the hard coating layer CA. After the transferring of the coating solution CS, a portion of the hard coating layer CA may be removed. For example, the removal of the portion of the hard coating layer CA may be performed along a second processing line CT2 parallel to the edge portion of the printing layer BM. The second processing line CT2 may be parallel to the thickness direction. A portion of the hard coating layer CA, which may not be in contact with the polymer film PL, the printing layer BM, or the sub-coating layer S-CA, may be removed, and as a result of this process, the cover window WD or WD-a may be formed to have a desired size.

The coating solution CS may include at least one of organic compounds and organic/inorganic composite compounds. The organic compounds may include acrylic compounds, epoxy compounds, or combinations thereof, and organic/inorganic compounds may include silicon compounds. For example, the coating solution CS may include at least one of methanol, isopropyl alcohol (IPA), isopropyl ether (IPE), acetone, methyl ethyl ketone (MEK), and propylene glycol methyl ether acetate (PGMEA). However, the material for the coating solution CS is not limited to these examples.

The coating solution CS may include solid ingredients whose content ranges from about 30 wt % to about 50 wt %. If the content of the solid ingredient in the coating solution is less than about 30 wt %, the coating solution may have low viscosity and may behave like a highly fluidic liquid. There may be a difficulty in uniformly forming the hard coating layer. If the content of the solid ingredient in the coating solution is higher than about 50 wt %, the coating solution may have high viscosity and may behave like a highly sticky substance. It may be difficult to supply the coating solution to a region below the printing layer and thereby to form the hard coating layer. Also, in the case where the coating solution includes solid ingredients whose content is higher than about 50 wt %, the coating solution may not be suitable for a solution process. In an embodiment, since the coating solution CS includes the solid ingredients of about 30 wt % to about 50 wt %, the coating solution CS may be used to uniformly form the hard coating layer CA and may be effectively used for the solution process.

By adjusting the content of the solid ingredients included in the coating solution CS, it may be possible to control an area of the hard coating layer CA. By adjusting the content of the solid ingredients, it may be possible to control an area of the second portion CA-A2 of the hard coating layer CA, which may overlap at least a portion of the bottom surface BM-DF of the printing layer BM. In the case where the content of the solid ingredients is low, it may be easy to supply the coating solution CS to the bottom surface BM-DF of the printing layer BM and to reduce a difference in area between the second portion CA-A2 and the bottom surface BM-DF of the printing layer BM. By contrast, in the case where the content of the solid ingredients is high, the coating solution CS may have high viscosity, and thus, the second portion CA-A2 may be formed to have an area that may be smaller than that of the bottom surface BM-DF of the printing layer BM.

According to an embodiment of the disclosure, a cover window may include a polymer film, a printing layer, and a hard coating layer. The hard coating layer may include a first portion, which may be provided to fully overlap the polymer film, a second portion, which may overlap at least a portion of a bottom surface of the printing layer, and a third portion, which may be disposed between the first portion and the second portion. The hard coating layer may protect the polymer film and the printing layer from an external impact, and thus, the cover window may have an improved mechanical robustness property.

According to an embodiment of the disclosure, a display device may include a display panel and a cover window on the display panel. The cover window may include a hard coating layer, and the cover window may have an improved mechanical robustness property. Accordingly, it may be possible to improve the reliability of the display device.

According to an embodiment of the disclosure, a method of fabricating a cover window may include providing a polymer film, providing a printing layer on a bottom surface of the polymer film, providing a coating solution on a top surface of the polymer film to form a hard coating layer. The hard coating layer may include a first portion, a second portion, and a third portion, which may be provided to cover the polymer film and at least a portion of the printing layer. The cover window fabricated by the fabrication method may exhibit an improved mechanical robustness property.

According to an embodiment of the disclosure, a cover window and a display device therewith may include a hard coating layer, and they may have an improved hardness or strength property.

According to an embodiment of the disclosure, a method of fabricating a cover window may include forming a hard coating layer, and the cover window may be fabricated to have an improved hardness or strength property.

While example embodiments of the disclosure have been particularly shown and described, it will be understood by one of ordinary skill in the art that variations in form and detail may be made therein without departing from the spirit and scope of the attached claims including equivalents thereof.

What is claimed is:

1. A cover window, comprising:
a polymer film;
a printing layer disposed below the polymer film; and
a hard coating layer including:
a first portion disposed on a top surface of the polymer film and overlapping the polymer film;
a second portion disposed on a bottom surface of the printing layer and overlapping the printing layer; and
a third portion disposed between the first portion and the second portion,
wherein an area of the second portion is smaller than an area of the printing layer in plan view.

2. The cover window of claim 1, wherein the third portion contacts a side surface of the polymer film and a side surface of the printing layer.

3. The cover window of claim 1, wherein the third portion extends from an end of the first portion.

4. The cover window of claim 1, wherein an edge of the polymer film overlaps an edge of the printing layer.

5. The cover window of claim 1, wherein the polymer film comprises:
a first polymer film having a first hardness; and
a second polymer film having a second hardness greater than the first hardness, the second polymer film being disposed on the first polymer film.

6. The cover window of claim 5, wherein
the first polymer film comprises polycarbonate, and
the second polymer film comprises poly methyl methacrylate.

7. The cover window of claim 5, wherein the second polymer film comprises a compound including fluorine.

8. The cover window of claim 5, wherein the polymer film further comprises a third polymer film having a third hardness greater than the first hardness, the third polymer film being disposed below the first polymer film.

9. The cover window of claim 1, wherein a thickness of the hard coating layer is in a range from about 5 μm to about 50 μm.

10. The cover window of claim 1, further comprising:
a sub-coating layer disposed between the polymer film and the printing layer,
wherein a hardness of the sub-coating layer is less than a hardness of the hard coating layer.

11. The cover window of claim 1, further comprising:
a sub-coating layer disposed between the polymer film and the printing layer,
wherein a thickness of the sub-coating layer is less than a thickness of the hard coating layer.

12. A method of fabricating a cover window, comprising:
providing a polymer film;
providing a printing layer on a bottom surface of the polymer film;
removing an edge portion of the polymer film, wherein the edge portion of the polymer film does not overlap the printing layer; and
providing a coating solution on a top surface of the polymer film to form a hard coating layer, wherein the hard coating layer comprises:
a first portion disposed on the top surface of the polymer film and overlapping the polymer film;
a second portion disposed on a bottom surface of the printing layer and overlapping the printing layer; and
a third portion disposed between the first portion and the second portion, and
an area of the second portion is smaller than an area of the printing layer, in plan view.

13. The method of claim 12, wherein the removing of the edge portion of the polymer film comprises:
removing the polymer film such that an edge of the polymer film overlaps an edge of the printing layer.

14. The method of claim 12, wherein the providing of the polymer film comprises:
providing a first polymer film having a first hardness; and
providing a second polymer film having a second hardness greater than the first hardness.

15. The method of claim 13, wherein the providing of the polymer film further comprises forming a sub-coating layer below the polymer film.

16. The method of claim 12, wherein the forming of the hard coating layer comprises diffusing the coating solution from the top surface of the polymer film to the bottom surface of the printing layer.

17. The method of claim 12, wherein
the coating solution includes a solid ingredient, and
a content of the solid ingredient is in a range from about 30 wt % to about 50 wt %.

18. The method of claim 12, wherein the coating solution comprises at least one of methanol, isopropyl alcohol, isopropyl ether, acetone, methyl ethyl ketone, and propylene glycol methyl ether acetate.

19. A display device, comprising:
a display panel; and
a cover window disposed on the display panel, wherein
the cover window comprises:
a polymer film;
a printing layer disposed below the polymer film; and
a hard coating layer including:
a first portion disposed on a top surface of the polymer film and overlapping the polymer film;
a second portion disposed on a bottom surface of the printing layer and overlapping the printing layer; and
a third portion disposed between the first portion and the second portion, and
an area of the second portion is smaller than an area of the printing layer in plan view.

20. The display device of claim 19, wherein the third portion contacts a side surface of the polymer film and a side surface of the printing layer.
